(19) United States
(12) Patent Application Publication
(10) Pub. No.: US 2021/0165266 A1
(43) Pub. Date: Jun. 3, 2021

(54) LIQUID CRYSTAL DISPLAY DEVICE

(71) Applicant: Japan Display Inc., Tokyo (JP)

(72) Inventors: Masaru NAKAKOMI, Tokyo (JP); Takeshi SATO, Tokyo (JP)

(73) Assignee: Japan Display Inc., Tokyo (JP)

(21) Appl. No.: 17/105,668

(22) Filed: Nov. 27, 2020

(30) Foreign Application Priority Data
Dec. 3, 2019 (JP) 2019-218689

(51) Int. Cl. G02F 1/1333; G02F 1/1335

(52) U.S. Cl. CPC G02F 1/133308; G02F 2001/133317; G02F 2001/133325; G02F 1/133528

(57) ABSTRACT

The purpose of the present invention is to supply a reference potential to a conductive film for shield formed on an outer major surface of the substrate without forming a voltage supply pad at the terminal area. An example of the concrete structure is: the liquid crystal display panel including a first substrate, on which wirings and pixels are formed, a first polarizing film adhered to the first substrate, a second substrate opposing to the first substrate, and a second polarizing plate adhered to the second substrate, the second substrate and the second polarizing plate being mutually adhered by a conductive adhesive, a back light including a metal component, the back light and the liquid crystal display panel being fixed by a conductive resin formed on a side surface of the metal component and a side surface of the liquid crystal display panel, the conductive resin electrically connecting with the conductive adhesive.

### CROSS-REFERENCE TO RELATED APPLICATION

The present application claims priority from Japanese Patent Application JP 2019-218689 filed on Dec. 3, 2019, the content of which is hereby incorporated by reference into this application.

### BACKGROUND OF THE INVENTION

### (1) Field of the Invention

The present invention relates to a liquid crystal display device having narrow picture frame which is suitable to a smart phone or tablet display and so forth.

### (2) Description of the Related Art

In the liquid crystal display device, a TFT substrate, on which the thin film transistors (TFT) and the pixel electrodes are arranged in matrix, and the counter substrate oppose to each other; the liquid crystal layer is sandwiched between the TFT substrate and the counter substrate. A transmittance of light is controlled in each of the pixels, thus, images are formed. Since the liquid crystal display device is flat and light, it is used in various fields.

Specifically, in the small or medium sized liquid crystal display devices, a larger screen size is required while keeping the outer size of the display panel constant; consequently, so called picture frame of the screen becomes narrower. On the other hand, since a liquid crystal display panel is not a self-luminescent device, a back light is necessary. Therefore, the back light is also necessary to have narrow peripheral frame.

Patent document 1 and patent document 2 disclose the structure of the liquid crystal display device of narrow picture frame in which the liquid crystal display panel and the back light are interconnected with plate shaped component or resin without using the resin mold.

On the other hand, the outer surface of the substrate of the liquid crystal display panel is sometimes required to be kept in reference potential. Patent document 3 discloses to connect the terminal of the reference voltage to the conductive film formed on the bottom of liquid crystal display panel by filling the conductive resin in the cut out of the outer frame which surrounds the liquid crystal display panel.

Patent document 1: Japanese patent application laid open No. 2019-82523

Patent document 2: Japanese patent application laid open No. 2014-126685

Patent document 3: Japanese patent application laid open No. 2010-204331

### SUMMARY OF THE INVENTION

When the picture frame of the liquid crystal display device is required to be narrow, the peripheral frame of the back light also must be narrow. In conventional back light, the light source, the light guide, the diffusing sheet, the prism sheet, the reflection sheet and so forth are installed in the resin mold. Then, the resin mold and the liquid crystal display panel are assembled with the black adhesive tape. Considering a mechanical strength of the resin mold, however, it is difficult to make narrow the frame width of the resin mold; consequently, there is a limit to attain a narrow frame back light with the resin mold.

On the other hand, in the liquid crystal display device of IPS (In Plane Switching) mode, the inside of the liquid crystal display panel is shielded by covering the surface of the counter substrate with the conductive film, and then a reference potential is applied to the conductive film. Conventionally, the voltage supplying pad formed in the terminal area of the TFT substrate and the conductive film of the surface of the counter substrate are interconnected with the conductive paste. However, according to the picture frame becomes narrower, it has become difficult to provide a space for the voltage suppling pad because enough area cannot be provided in the terminal area.

The purpose of the present invention is to realize the structure for supplying reference potential to the surface of the counter substrate without using the reference voltage supplying pad, and thus to realize the liquid crystal display device of narrow picture frame.

The present invention solves the above explained problems; the concrete measures are as follows.

(1) A liquid crystal display device including: a liquid crystal display panel and a back light, in which

the liquid crystal display panel includes a first substrate, on which wirings and pixels are formed, a first polarizing film adhered to the first substrate, a second substrate opposing to the first substrate, and a second polarizing plate adhered to the second substrate,

the second substrate and the second polarizing plate are mutually adhered by a conductive adhesive,

the back light includes a metal component,

the back light and the liquid crystal display panel are fixed by a conductive resin formed on a side surface of the metal component and a side surface of the liquid crystal display panel, and

the conductive resin electrically connects with the conductive adhesive.

(2) A liquid crystal display device including: a liquid crystal display panel and a back light, in which

the liquid crystal display panel includes a first substrate, on which wirings and pixels are formed, a first polarizing film adhered to the first substrate, a second substrate opposing to the first substrate, and a second polarizing plate adhered to the second substrate,

a transparent conductive film is formed on a surface of the second substrate to which the second polarizing plate is adhered,

the back light includes a metal component,

the back light and the liquid crystal display panel are fixed by a conductive resin formed on a side surface of the metal component and a side surface of the liquid crystal display panel, and

the conductive resin electrically connects with the transparent conductive film.

### BRIEF DESCRIPTION OF THE DRAWINGS

FIG. 1 is a plan view of the liquid crystal display device when the present invention is not used;

FIG. 2 is a cross sectional view of FIG. 1 along the line A-A;

FIG. 3 is a cross sectional view of FIG. 1 along the line B-B;

FIG. 4 is a plan view of embodiment 1 of the present invention;

FIG. 5 is a schematic diagram of a coating process of the conductive resin;

FIG. 6 is a cross sectional view of FIG. 4 along the line C-C;

FIG. 7 is a plan view of embodiment 2 of the present invention;

FIG. 8 is a cross sectional view of embodiment 3 of the present invention.

### DETAILED DESCRIPTION OF THE PREFERRED EMBODIMENTS

The present invention is explained in the following embodiments in detail.

### Embodiment 1

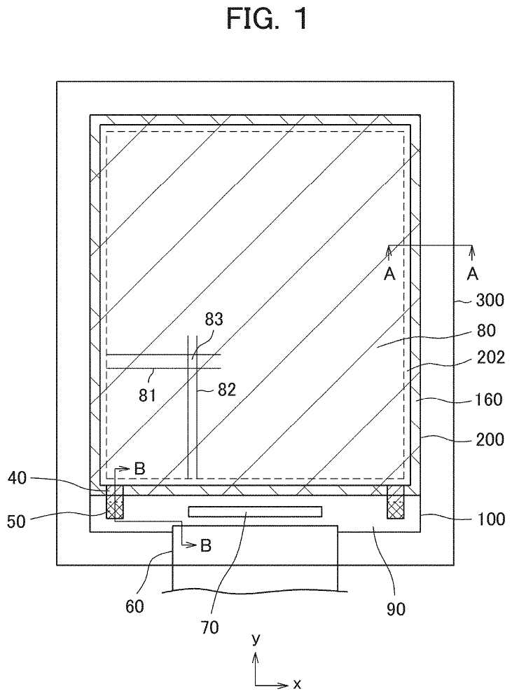

FIG. 1 is a plane view of the liquid crystal display device in which the present invention is to be applied. In FIG. 1, the TFT substrate 100 and the counter substrate 200 are mutually adhered by the sealing material 160; the liquid crystal is sealed in the inner side from the sealing material. The upper polarizing plate 202 is adhered on the upper surface of the counter substrate 200. The display area 80 is formed where the TFT substrate 100 and the counter substrate 200 overlap.

In the display area 80 of FIG. 1, the scan signal lines 81 extend in lateral direction (x direction) and are arranged in longitudinal direction (y direction); the video signal lines 82 extend in longitudinal direction and are arranged in lateral direction. The pixel 83 is formed in the area surrounded by the scan signal lines 81 and the video signal lines 82.

The TFT substrate 100 is made larger than the counter substrate 200; the terminal area 90 is formed where the TFT substrate 100 does not overlap the counter substrate 200. The driver IC 70 to drive the liquid crystal display device is installed on the terminal area 90; the flexible wiring substrate 60 connects to the terminal area 90 to supply the power and the signals to the liquid crystal display device. The back light 500 is set behind the liquid crystal display panel although it is not depicted in FIG. 1.

In FIG. 1, the cover glass 300 is adhered through the transparent adhesive on the upper polarizing film 202, which is formed on the liquid crystal display panel. A transparent resin plate may be used instead of the cover glass 300; however, it is also referred to as the cover glass 300 in this specification for convenience. In FIG. 1, since the cover glass 300 is transparent, the liquid crystal display panel is seen through the cover glass 300. The cover glass 300 is made larger than the liquid crystal display panel. In FIG. 1, in the side of the terminal area 90, the flexible wiring substrate 60 extends outwardly than the outer edge of the cover glass 300; however, the flexible wiring substrate 60 is ultimately bent and set beneath the cover glass 300.

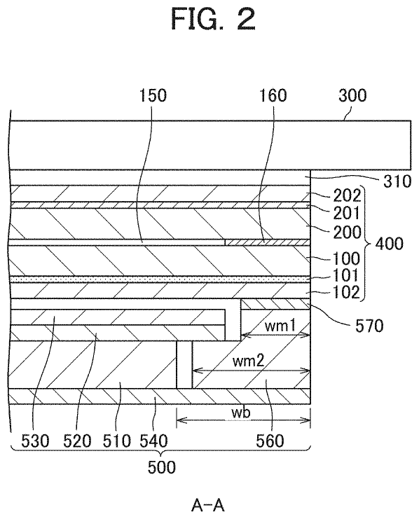

FIG. 2 is a comparative example of the cross sectional view along the line A-A in FIG. 1, in which each of the components of the back light 500 are installed in the resin mold 560. In FIG. 2, the cover glass 300 is adhered on the liquid crystal display panel 400 through the transparent adhesive 310. Herein after, the assembly of the TFT substrate 100, the lower polarizing plate 102, the counter substrate 200 and the upper polarizing plate 202 is referred to as the liquid crystal display panel 400. The back light 500 is set below the liquid crystal display panel 400; the liquid crystal display panel 400 is adhered to the back light 500 through the black adhesive tape 570 formed on the upper surface of the resin mold 560.

In FIG. 2, the cover glass 300 is thickest, and is e.g. 0.5 to 0.7 mm thickness. By the way, FIG. 2 is a model for explanation, which is different from the figure of the real product; it is the same for FIG. 1 and other figures. The cover glass 300 and the liquid crystal display panel 400, concretely the upper polarizing plate 202 of the liquid crystal display panel 400, are mutually adhered by the transparent adhesive 310 of the acrylic resin base.

In FIG. 2, the TFT substrate 100, in which the scan signal lines, the pixels and so forth are formed, adheres to the counter substrate 200. The liquid crystal 150 is sandwiched between the TFT substrate 100 and the counter substrate 200; the TFT substrate 100 and the counter substrate 200 adhere to each other through the seal material 160.

In FIG. 2, the lower polarizing plate 102 is adhered to the lower surface of the TFT substrate 100 through the adhesive 101; the upper polarizing plate 202 is adhered to the upper substrate 200 through the conductive adhesive 201. Each a thickness of the upper polarizing plate 202 and a thickness of the lower polarizing plate 102 is e.g. 100 microns; each a thickness of the adhesive 101 for the polarizing plate and a thickness of the conductive adhesive 201 is e.g. 30 microns.

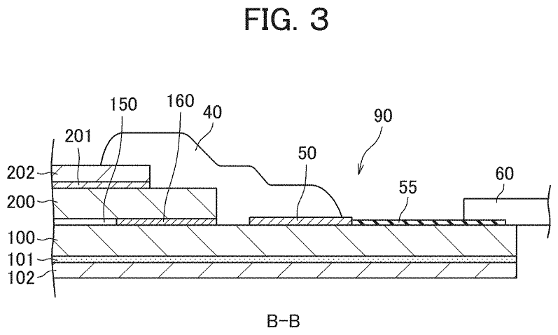

Since the electrode is not formed on the counter substrate 200 in the IPS mode liquid crystal display device, the conductive film is formed on the surface of the counter substrate 200, opposing side to the cover glass 300, and apply the reference potential to the conductive film to form a shield in order to prevent invasion of noise from outside. In FIG. 2, since the conductive adhesive 201 is formed on all the surface of the counter substrate 200, it can work as a shield of the liquid crystal display panel 400. For this purpose, a reference potential must be applied to the conductive adhesive 201; thus, conventionally, the structures shown in FIG. 1 and FIG. 3 are adopted as will be explained later.

The back light 500 is set behind the liquid crystal display panel 400. The elements of the back light 500 are set in the resin mold 560. The LEDs are used as a light source, however, the LEDs do not exist at the position of FIG. 2; thus, the LEDs are omitted from the figure. By the way, the LEDs are generally set at the side of the terminal area 90 of FIG. 1 in the back light 500.

In FIG. 2, the reflection sheet 540 is set at the lower surface of the light guide 510. The reflection sheet 540 reflects the light from the light guide 510 in the direction to the liquid crystal display panel 400. The light guide 510, which has a thickness of e.g. 200 microns, is thickest among the back light components.

The optical sheet group is set on the light guide 510. The optical sheet group includes the diffusing sheet 520 and the prism sheet 530. Although one diffusing sheet 520 and one prism sheet 530 are described in FIG. 2, there are several variations for the optical sheet group in the actual devices. For example, instead to the structure of FIG. 2, the structure of the optical sheet group can have four sheets of the lower diffusing sheet, lower prism sheet, upper prism sheet and the upper diffusing sheet stacked in this order on the light guide 510. The optical sheets 520 and 530 can extend on the shoulder of the resin mold 560 and fixed to the resin mold 560 through the adhesive. A thickness of each of the optical sheets 520 and 530 is approximately 50 microns.

In FIG. 2, the liquid crystal display panel 400 is fixed on the upper surface of the resin mold 560 through e.g. the black adhesive tape 570. A width wm1 of approximately 300 microns is necessary for the top of the resin mold 560 to securely fix the liquid crystal display panel 400 to the resin mold 560. Further, a width wm2 of approximately 600 microns is necessary for the resin mold 560 to securely fix the optical sheets 520 and 530 to the resin mold 560. The black adhesive tape 570 is used for light shading. A thickness of the black adhesive tape 570 is e.g. 30 microns.

In FIG. 2, when an edge of the effective area of the back light 500 coincides to the edge of the light guide 510, the frame width of the back light 500 is wb. The frame width wb is relatively large because the resin mold 560 exists. In FIG. 2, a light shielding structure is not formed on the side of the TFT substrate 100 and the counter substrate 200, which constitutes the liquid crystal display panel 400; however, if the light shielding structure is formed on those sides, the frame width wb of the back light 500 becomes yet larger.

FIG. 3 is a cross sectional view of FIG. 1 along the line B-B, which is a cross sectional view of conventional structure to supply the reference potential to the conductive adhesive 201 of the upper polarizing plate 202, which can work as a shield. The cover glass and back light are omitted in FIG. 3. In FIG. 3, the TFT substrate 100 and the counter substrate 200 are mutually adhered by the seal material 160, the liquid crystal 150 is sandwiched between the TFT substrate 100 and the counter substrate 200. The voltage supplying pad 50 to supply the reference potential is formed on the terminal area where the TFT substrate 100 does not overlap the counter substrate 200; the voltage supplying pad 50 is connected to the flexible wiring substrate 60 through the reference voltage supplying wiring 55.

In FIG. 3, the reference voltage supplying pad 50 and the conductive adhesive 201 electrically connect through the conductive paste 40. Since the conductive paste 40 is a fluid of big viscosity before drying, it can flexibly deform its shape and be in close contact with the side surface of the conductive adhesive 201. A resin dispersed with metal particles is mostly used as the conductive paste 40; the most popular one is a silver paste, which uses silver particles.

The area of the terminal area 90, however, is also needed to be smaller according to the picture frame becoming narrower. Accordingly, for example, the driver IC 70 tends to be installed on the flexible wiring substrate 60, not on the terminal area 90. In addition, it becomes difficult to provide the space for the voltage supplying pad 50, the voltage supplying wiring 55 and the coating area for the conductive paste 40 in the terminal area 90. Consequently, it becomes an important problem how to supply the reference voltage to the conductive adhesive 201 of the upper polarizing plate 202.

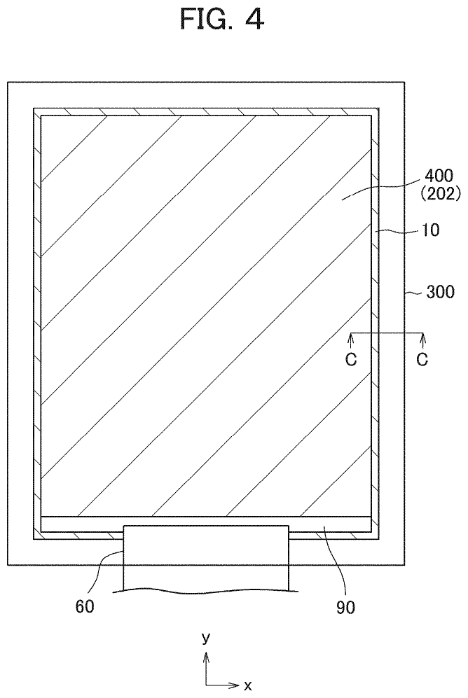

FIG. 4 is a plan view of the present invention. In FIG. 4, which is a counter structure of FIG. 1, the cover glass 300 is disposed on the upper polarizing plate 202 of the liquid crystal display panel 400; the back light 500 is set behind the liquid crystal display panel 400. The structure of the liquid crystal display panel 400 is the same as explained in FIG. 1; cover glass 300 is also the same as explained in FIG. 2.

Comparing with the structure of FIG. 1, the structure of FIG. 4 has narrower width in the terminal area 90; the voltage supplying pad, the conductive paste and so forth are not formed on the terminal area 90; the driver IC is not installed on the terminal area 90 but installed on the flexible wiring substrate 60. The liquid crystal display panel 400 and the back light 500, which is set behind the liquid crystal display panel 400, are fixed by coating the conductive resin 10 on the side surfaces of the liquid crystal display panel 400 and the back light 500. The reference potential is supplied to the counter substrate 200 of the liquid crystal display panel 400 through the conductive resin 10. In the meantime, when black conductive resin 10 is used, a leak of light from the sides of the liquid crystal display panel 400 and the back light 500 can be prevented.

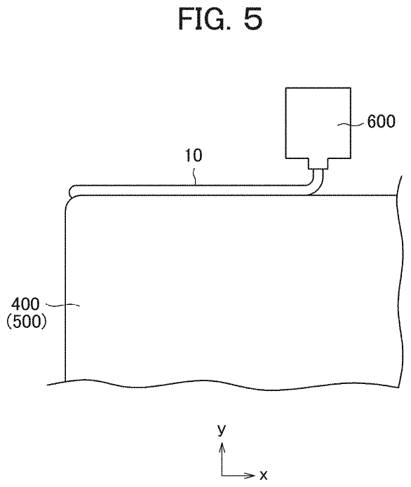

The conductive resin 10 is a so called hot-melt adhesive, which is a thermoplastic resin that liquidizes when it is heated at a temperature of 90 to 100 centigrade. As depicted in FIG. 5, the conductive resin 10 is heated in a so called hot gun 600, which has a heater in it, and is simultaneously coated on the side surfaces of the liquid crystal display panel 400 and the side surface of the back light 500. Although there are several types of conductive resin 10, the current embodiment uses the resin that is cured by absorbing moisture in the air.

The viscosity of the conductive resin 10 when it is coated is 2000 to 10000 mPa·s (milli Pascal·sec), more favorably, 2000 to 10000 mPa·s at 100 centigrade. Workability decreases when viscosity is too high. When the viscosity is too low, there is a chance the conductive resin 10 intrudes into a space in the back light 500 through a gap between the liquid crystal display panel 400 and the back light 500.

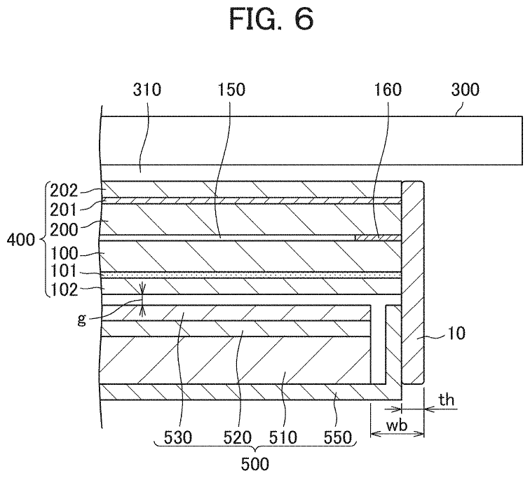

FIG. 6 is a cross sectional view of FIG. 4 along the line C-c. In FIG. 6, the structure of the liquid crystal display panel 400 and the cover glass 300 are the same as explained in FIG. 2. The feature of FIG. 6 is the structure of back light 500 and the means to fix the liquid crystal display panel 400 and the back light 500. In FIG. 6, the light guide 510, the diffusing sheet 520, prism sheet 530 and so forth are set in the metal frame 550 made of e.g. stainless steel. Since metal frame 550 provides a good strength and a good walkability, a thickness of the frame can be as less as 0.1 to 0.15 mm. In addition, since the frame 550 is formed as box like, it is easy to secure a mechanical strength. By the way, even the metal frame 550 works as the reflection sheet in FIG. 6, an independent reflection sheet can be set under the light guide 510.

In FIG. 6, the conductive resin 10 is set on the side surface of the metal frame 550 and the side surface of the liquid crystal display panel 400 to fix the metal frame 550 and the liquid crystal display panel 400. In the meantime, a predetermined gap g is formed between the lower polarizing plate 102 of the liquid crystal display panel 400 and the optical sheet group, e.g. the prism sheet 530 of the back light 500, to prevent a generation of so called Newton ring; this gap g is also maintained by the conductive resin 10. A thickness th of the conductive resin 10 is e.g. 0.15 to 0.3 mm.

Since the structure of FIG. 6 does not use the resin mold, the picture frame width wb of the back light can be made substantially narrower; in other words, it is because, in the structure of FIG. 6, a thickness of the conductive resin 10 can be made as thin as approximately 0.2 mm and a thickness of the metal frame 550 can be made as thin as approximately 0.15 mm, in concretely.

In FIG. 6, the conductive adhesive 201, which adheres the counter substrate 200 to the upper polarizing film 202 and also works as a shield, electrically connects with the metal frame 550, which is supplied with reference potential, through the conductive resin 10. Therefore, the voltage supplying pad 50 and so forth can be eliminated from the terminal area 90.

The conductive resin 10 connects with the side surface of the conductive adhesive 201, which has a thickness of 30 microns. Since the conductive resin 10 is a fluid of high viscosity when it is coated by the dispenser, it can flexibly contact the side surface of the thin conductive adhesive 201. In addition, since the conductive resin 10 is coated all around the side surface of the liquid crystal display panel 400, the conductive resin 10 and the conductive adhesive 201 can be electrically connected securely.

In FIG. 6, the side surface of the upper polarizing plate 202 and the conductive adhesive 201 and the side surface of the counter substrate 200 are flush with each other; however, even if an edge of the side surface of the upper polarizing plate 202 and the conductive adhesive 201 protrudes from the side surface of the counter substrate 200 or recedes from the side surface of the counter substrate 200, the conductive resin 10 can cover those recess and protrusion and connect with the conductive adhesive 201 flexibly before it is cured by absorbing moisture in the air. Such function is the same when the conductive adhesive 10 is not moisture set resin, but it is thermoset resin or ultra violet ray set resin and so forth.

The conductive resin 10 is that the fine conductive particles are dispersed in the base resin as: EVA based, polyolefin based, synthetic rubber based, adhesive polymer based (polyethylene based or nylon based) or so forth. If the carbon, as graphite, is used as the conductive fine particles, the conductive resin 10 can be made black; therefore, conductive resin 10 can be also used as a light shading material on the side surfaces of the liquid crystal display panel 400 and the back light 500.

In FIG. 6, many wirings are formed on the TFT substrate 100; those wrings, however, should not reach to the edge of the TFT substrate 100 to prevent those wirings are being short by the conductive resin 10. In FIG. 6, the adhesive 101, which adheres the TFT substrate 100 to the lower polarizing plate 101, is not necessary to be conductive; however, when the TFT substrate 100 is necessary to be shielded from some reasons, the conductive adhesive 201 can be used.

As described above, according to embodiment 1, the voltage supplying pad 50 or the conductive paste 40 to supply the reference potential to the conductive film for shielding formed on the counter substrate 200 can be eliminated from the terminal area 90; thus, the liquid crystal display device of narrow picture frame can be realized.

### Embodiment 2

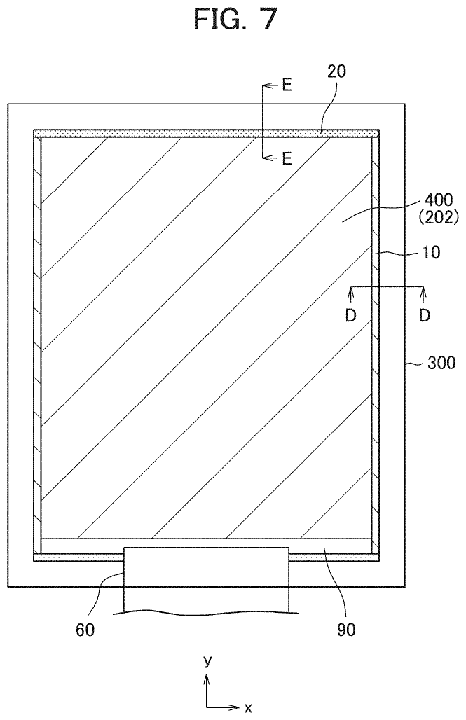

FIG. 7 is a plan view of embodiment 2 of the present invention. FIG. 7 differs from FIG. 4 in that the conductive resin 10 is formed only on the side surfaces of the long sides of the liquid crystal panel 400 and the back light 500, and the conductive resin 10 is not formed on the side surfaces of the short sides. The cross sectional view of FIG. 7 along the line D-D is the same as FIG. 6. The cross sectional view of FIG. 7 along the line E-E differs from FIG. 7 only in that the conductive resin 10 is substituted by the non-conductive resin 20.

In the short sides of the liquid crystal display panel 400, specifically at the side the terminal area 90 is formed, many terminals are formed at the edge of the TFT substrate 100; and the flexible wiring substrate 60 connects to the terminals. Therefore, if the conductive resin 10 exists near the terminals of the TFT substrate 100, there is a chance that the terminals are shorted.

The structure of FIG. 7 can avoid this problem because the conductive resin 10 is formed only on long sides of the liquid crystal display panel 400 and the back light 500; and the non-conductive resin 20 is formed on the short sides. The enough contact area between the conductive adhesive 201 of the upper polarizing plate 202 and the conductive resin 10 can be secured even only at the long sides, thus, the reliability can be maintained.

Since the counter substrate 200 does not exist at the side of terminal area of the TFT substrate 100, the reference potential cannot be supplied from terminal area 90 to the upper side of the counter substrate 200. Therefore, it is not necessary to form the conductive resin 10 at the side of the terminal area 90.

In FIG. 7, the conductive resin 10 is formed only at the long sides; however, the conductive resin 10 can be formed at the short side opposite to the side of the terminal area 90. In addition, according to a layout of wirings formed on the TFT substrate 100, the conductive resin 10 can be formed only on one side of the short sides or long sides of the liquid crystal display panel 400 and the back light 500.

### Embodiment 3

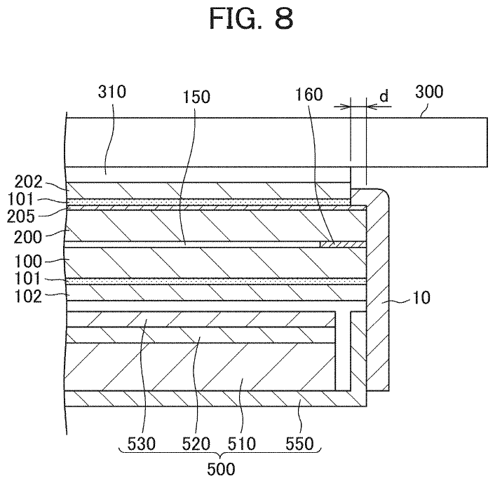

FIG. 8 is a cross sectional view of embodiment 3 of the present invention. FIG. 8 is different from FIG. 6 in that the conductive transparent conductive film 205 as e.g. ITO (Indium Tin Oxide) is formed on the surface of the counter substrate 200 to shield the liquid crystal display panel 400. The transparent conductive film 205 is formed e.g. by sputtering. In this case, the adhesive 101 that adheres the upper polarizing plate 202 to the counter substrate 200 needs not to be conductive.

In the structure of FIG. 8, the conductive resin 10, which connects with the metal frame 550, connects with the transparent conductive film 205 formed on the surface of counter substrate 200. The transparent conductive film 205 is made thin as 100 nm so that the transmittance is not substantially decreased. In FIG. 8, the upper polarizing plate 202 is made slightly smaller than the counter substrate; consequently, the edge of the upper polarizing plate 202 slightly recedes from the edge of the counter substrate 200 by a distance d.

Since the conductive resin 10 is a fluid of high viscosity when it is coated, it can flexibly intrude into this slight distance d, and can contact the transparent conductive film 205; thus, connection between the transparent conductive film 205 and the metal frame 550 can be attained.

Other structure of FIG. 8 is the same as FIG. 6. In the meantime, even FIG. 8 uses the non-conductive resin 101 for adhesion between the counter substrate 200 and the upper polarizing film 202, the conductive adhesive 201 can be used as in the structure of FIG. 6 if necessary. In addition, as shown in FIG. 7 and so forth, the conductive resin 10 can be formed only at the long sides of the liquid crystal display panel 400 and the back light 500 as explained in embodiment 2.

As described above, the present invention can be applied in any cases as e.g. the shielding conductive film on the surface is conductive adhesive 201, which adheres the upper polarizing plate 202 to the counter substrate 200 or the transparent conductive film 205 of e.g. ITO formed on the surface of the counter substrate 200.

What is claimed is:

1. A liquid crystal display device comprising: a liquid crystal display panel and a back light, wherein
the liquid crystal display panel includes a first substrate, on which wirings and pixels are formed, a first polarizing film adhered to the first substrate, a second substrate opposing to the first substrate, and a second polarizing plate adhered to the second substrate,
the second substrate and the second polarizing plate are mutually adhered by a conductive adhesive,
the back light includes a metal component,
the back light and the liquid crystal display panel are fixed by a conductive resin formed on a side surface of the metal component and a side surface of the liquid crystal display panel, and
the conductive resin electrically connects with the conductive adhesive.

2. The liquid crystal display device according to claim 1,
wherein the conductive resin is made of a thermoplastic resin.

3. The liquid crystal display device according to claim 1,
wherein the conductive resin is formed at least on one side of the liquid crystal display panel.

4. The liquid crystal display device according to claim 1,
wherein, the first substrate has a terminal area,
the conductive resin is not formed at a side where the terminal area is formed.

5. The liquid crystal display device according to claim 1,
wherein the conductive resin is formed at a side of a long side of the liquid crystal display panel.

6. The liquid crystal display device according to claim 1,
wherein the wirings do not extend to an edge of the first substrate at a side the conductive resin is formed.

7. A liquid crystal display device comprising: a liquid crystal display panel and a back light, wherein
the liquid crystal display panel includes a first substrate, on which wirings and pixels are formed, a first polarizing film adhered to the first substrate, a second substrate opposing to the first substrate, and a second polarizing plate adhered to the second substrate,
a transparent conductive film is formed on a surface of the second substrate to which the second polarizing plate is adhered,
the back light includes a metal component,
the back light and the liquid crystal display panel are fixed by a conductive resin formed on a side surface of the metal component and a side surface of the liquid crystal display panel, and
the conductive resin electrically connects with the transparent conductive film.

8. The liquid crystal display device according to claim 7,
wherein the second substrate is larger than the second polarizing film in a plan view.

9. The liquid crystal display device according to claim 7,
wherein the conductive resin contacts the transparent conductive film at an edge of the major surface of the second substrate.
